(19) United States
(12) Patent Application Publication
(10) Pub. No.: US 2014/0211779 A1
(43) Pub. Date: Jul. 31, 2014

(54) SCALABLE SYNCHRONIZATION FOR DISTRIBUTED MULTIUSER MIMO

(71) Applicants: Ryan Rogalin, Los Angeles, CA (US); Giuseppe Caire, South Pasadena, CA (US); Horia Vlad Balan, Los Angeles, CA (US); Konstantinos Psounis, Pacific Palisades, CA (US)

(72) Inventors: Giuseppe Caire, South Pasadena, CA (US); Konstantinos Psounis, Pacific Palisades, CA (US); Horia Vlad Balan, Los Angeles, CA (US); Ryan Rogalin, Los Angeles, CA (US)

(73) Assignee: UNIVERSITY OF SOUTHERN CALIFORNIA, Los Angeles, CA (US)

(21) Appl. No.: 13/955,969

(22) Filed: Jul. 31, 2013

Related U.S. Application Data
(60) Provisional application No. 61/759,006, filed on Jan. 31, 2013.

(51) Int. Cl. H04W 56/00

(52) U.S. Cl. CPC H04W 56/0015
USPC 370/350

(57) ABSTRACT

Each wireless access point in a network may transmit pilot bursts; receive pilot bursts; determine the timing, carrier frequency, and/or sampling frequency of each received pilot burst; determine an offset between the timing, carrier frequency, and/or sampling frequency of each received pilot burst and its own transmitted signals; and deliver one or more of these determined offsets to a computer server. The computer server may receive these offsets and, based on them, compute and deliver to each wireless access point a timing, carrier frequency, and/or sampling frequency correction factor. Each wireless access point may adjust its transmitted timing, carrier frequency, and/or sampling frequency in accordance with these correction factors.

### CROSS-REFERENCE TO RELATED APPLICATION

This application is based upon and claims priority to U.S. provisional patent application 61/759,006, entitled “SCALABLE SYNCHRONIZATION FOR DISTRIBUTED MULTIUSER MIMO,” filed Jan. 31, 2013, attorney docket number 028080-0834.

The entire content of this application is incorporated herein by reference.

### BACKGROUND

1. Technical Field

This disclosure relates to synchronization of wireless access points in a distributed multiuser MIMO (multiple input and multiple output) network system.

2. Description of Related Art

Distributed Multiuser MIMO (MU-MIMO) refers to a wireless network (e.g., WLAN or network of small cells in a heterogeneous cellular architecture) where multiple wireless access points (APs) are typically connected to a central server (CS) through a wired backhaul network and act as a single distributed MIMO transmitter serving multiple users through some form of spatial multiplexing.

Downlink channels can be estimated by the CS using either TDD reciprocity or using explicit downlink training and feedback. Under the assumption of ideal timing and frequency synchronization between the Aps and using estimated downlink channels, the CS may centrally compute precoded signals or distributed beamforming techniques can be used. In either case, the system may become conceptually equivalent to a centralized MU-MIMO downlink system with noisy channel state information at the transmitter. See R. Irmer, H. Droste, P. Marsch, M. Grieger, G. Fettweis, S. Brueck, H.-P. Mayer, L. Thiele, and V. Jungnickel, “Coordinated multipoint: Concepts, performance, and field trial results,” Communications Magazine, IEEE, vol. 49, no. 2, pp. 102-111, february 2011; G. Caire, N. Jindal, M. Kobayashi, and N. Ravindran, “Multiuser MIMO achievable rates with downlink training and channel state feedback,” IEEE Trans. Inf. Theory, vol. 56, no. 6, pp. 2845-2866, 2010, and references therein.

However, when the APs are made of inexpensive hardware and are connected via a data network with relatively coarse timing information (e.g., Ethernet), a lack of synchronization between them may cause problems in achieving a truly distributed MU-MIMO system.

### SUMMARY

A computer network system may include multiple wireless access points and a computer server.

Each wireless access point may include a transmitter, a receiver, and a processing system.

Each transmitter may wirelessly transmit signals having a timing, carrier frequency, and/or sampling frequency, including pilot bursts.

Each receiver may wirelessly receive signals having a timing, carrier frequency, and/or sampling frequency, including pilot bursts.

Each processing system may cause the transmitter within its wireless access point to transmit pilot bursts.

Each processing system may determine the timing, carrier frequency, and/or sampling frequency of each received pilot burst.

Each processing system may determine a timing offset between the timing of each received pilot burst and the timing of the transmitted signals within its wireless access point.

Each processing system may determine a carrier frequency offset between the frequency of each received pilot burst and the carrier frequency of the transmitted signals within its wireless access point.

Each processing system may determine a sampling frequency offset between the sampling frequency of each received pilot burst and the sampling frequency of the transmitted signals within its wireless access point.

Each processing system may compute the timing, carrier frequency, and/or sampling frequency offsets using a joint maximum likelihood timing estimator.

Each processing system may determine a timing offset as small as ten or two or even less nanoseconds.

Each transmitter may have a radio signal bandwidth. Each processing system may determine a timing offset as small as ten, two, or even less times the inverse of the radio signal bandwidth within its wireless access point.

Each wireless access point may include a network communication system that communicates with a computer server through a computer network. Each processing system may cause the network communication system to deliver the determined timing, carrier frequency, and/or sampling frequency offsets to the computer server through the computer network.

The computer server may include a network communication system and a processing system.

The network communication system within the computer server may communicate with each of the wireless access points through a computer network. The computer network may be a backhaul network.

The processing system in the computer server may receive from each of the wireless access points a timing offset, a carrier frequency offset, and/or a sampling frequency offset. The processing system in the computer server may instead compute a sampling frequency offset between each wireless access point and another of the wireless access points based on the timing offset and the carrier frequency offset received from the wireless access point.

The processing system may compute a timing correction factor, a carrier frequency correction factor, and/or a sampling frequency correction factor for each wireless access point based on, respectively, the timing, carrier frequency, and sampling frequency offsets received from the wireless access points or, in the case of the sampling frequency offset, the sampling frequency offset computed by the processing system. The processing system may cause the timing, carrier frequency, and/or sampling frequency correction factors for each wireless access point to be delivered to that wireless access point through the computer network system.

The processing system in the computer server may compute the timing, carrier frequency, and/or sampling frequency correction factors using a least-squares algorithm and/or using a smoothing filter algorithm that smoothens the correction factors in time across successive synchronization protocol slots.

The processing system in each wireless access point may cause the timing of the transmitted signals to be adjusted in accordance with the timing correction factor received from the computer server.

The processing system in each wireless access point may cause the carrier frequency of the transmitted signals to be adjusted in accordance with the carrier frequency correction factor received from the computer server. The processing system in each wireless access point may cause the carrier frequency of the transmitted signals to be adjusted by phase rotating transmit symbols in a baseband in accordance with the carrier frequency correction factor.

The processing system in each wireless access point may cause the sampling frequency of the transmitted signals to be adjusted in accordance with the sampling frequency correction factor received from the computer server. The processing system in each wireless access point may causes the sampling frequency of the transmitted signals to be adjusted by a combination of phase rotation in a baseband and a sample skipping scheme that repeats samples or deletes samples to adjust timing alignment of transmissions.

The processing system in the computer server may compute the timing, carrier frequency, and sampling frequency correction factors in amounts that cause each of the wireless access points upon receipt of their respective correction factors to synchronize with one of the wireless access points which is the same for all of the wireless access points.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates an example of achievable rates for a 4×4 distributed MU-MIMO system with synchronization impairments.

FIG. 2 illustrates an example of a frame structure of a distributed MU-MIMO architecture.

FIG. 3 illustrates an example of a network graph with three anchor nodes (triangles) making use of different pilot bursts (represented by arrows with three different shades of grey, indicating the different bursts transmitted at different times, in sequence) and synchronizing a number of other non-anchor nodes indicated by squares.

FIGS. 4A and 4B illustrate an example of achievable rates versus time of a 4×4 system after synchronization.

FIG. 5 illustrates an example of a CDF of a time-to-asynchronism (time until two APs are more than a CP asynchronous) of an imperfect sample skipping mechanism.

FIG. 6 illustrates an example of a CRB and simulated estimation MSE of a joint ML estimation for parameters of the example.

FIG. 7 illustrates an example of a computer network system having multiple wireless access points and a computer server.

FIG. 8 illustrates an example of a wireless access point.

FIG. 9 illustrates an example of a computer server.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

Now described are a protocol and an underlying algorithm for efficient estimation and compensation of timing, sampling frequency, and/or carrier frequency offsets between wireless access points (APs) in a computer network system. The technology may be fully scalable when each AP in the network can communicate with at least one other AP. The technology may be applied to any off-the-shelf timing and frequency estimator. Also addressed is the problem of joint timing and frequency estimation by considering the presence of a multi path channel with known path delays, but unknown path coefficients.

Features of this technology may include:

1. A protocol for providing carrier frequency, sampling frequency, and timing reference synchronism to multiple access points (APs) connected via a wired or wireless backhaul to a central server (CS). Each AP may be any type of wireless access point, such as a WiFi access point or a cellular network access point.
2. A protocol that includes periodic repetition of “pilot bursts,” i.e., known waveforms, such that each AP in the network is able to receive one or more pilot burst from other APs, and to transmit one or more pilot bursts that are received by at least one other AP. The graph having the APs as nodes and edges between two nodes whenever the two APs can send and receive their pilot bursts, respectively, may cover the whole network as a single connected component.
3. If the graph described above splits in two or more connected components, the proposed protocol can be run separately on each connected component.
4. Upon reception of a pilot burst from some other AP, each AP may estimate a relative timing offset (TO) and carrier frequency offset (CFO). A sampling frequency offset (SFO) may be obtained from the CFO since sampling and carrier frequency may be derived from the same clock, on each AP.
5. Any suitable timing and carrier frequency offset estimators can be used and incorporated into the technology, as building blocks. Each estimator may produce sufficiently accurate estimates of the TO and CFO between two APs, in a pilot-aided or non-pilot-aided manner.
6. The APs may send their TO and CFO measurements to the CS via a network backhaul.
7. The CS may compute timing correction factors, carrier frequency “additive” correction factors, and sampling frequency “multiplicative” correction factors, and send them back to the APs.
8. Each AP can correct its timing by delaying its time axis reference by the TO correction factor.
9. Each AP may correct its carrier frequency by phase rotating the transmit symbols in the base band by the CFO correction factor. Alternatively, if the APs are equipped with a digitally controlled VCO, they may change the VCO frequency accordingly.
10. Each AP may correct its sampling frequency by a combination of phase rotation in the baseband and a sample skipping scheme that repeats samples or delete samples in order to adjust the timing alignment of transmissions. Alternatively, if the APs are equipped with a digitally controlled VCO, they can adjust the VCO frequency accordingly. In this case, there may be no need for an explicit correction of the sampling frequency. (It may be automatically accomplished while correcting the carrier frequency.)
11. Centralized computation of the correction factors at the CS can be implemented in different ways. In particular, a least-squares (LS) approach may be used.
12. A smoothing filer (for example, Recursive Least-Squares, or Kalman filter) may in addition or instead be used to smooth out the correction factor in time, across successive synchronization protocol slots. This option may be useful when the local clock frequencies fluctuate in a smooth way over time (e.g., due to temperature variations).
13. If there exists at least one AP equipped with a very precise clock (e.g., oven-controlled oscillator) in the network, the precision of this clock may be transferred to the whole network using a protocol that is described.
14. As an option for timing and frequency estimation from the pilot bursts at each AP, a joint ML timing estimator may be used that explicitly addresses the presence of an unknown multi path channel with known path delays and unknown path coefficients. However, the protocol can incorporate any suitable timing and frequency estimator at the AP nodes, not necessarily joint ML. In fact, any existing off-the-shelf estimator may be incorporated as a building block of the proposed protocol.

### Technical Details

Consider a transmitter and a receiver at fixed positions, such that the channel can be considered linear time-invariant with additive white Gaussian noise. Letting f₀ and fₛ=1/Tₛ be the nominal carrier and sampling frequencies at all nodes of a wireless network, respectively, the actual carrier and sampling frequencies may differ from their nominal values by some deterministic unknown quantity. Let f_{0,i} and f_{s,i}=1/T_{s,i} denote the carrier and sampling frequencies at node i, respectively. Further, node i may be affected by its own timing offset (TO) τᵢ with respect to the origin of the nominal time axis.

Consider the transmission of a sequence of OFDM symbols from node i to node j. Let Xᵢ[n]=(Xᵢ[n,0], . . . , Xᵢ[n,N−1]) denote the n-th block of frequency-domain symbols (i.e., the n-th OFDM symbol), where N indicates the number of OFDM subcarriers and where Xᵢ[n,v] is the complex baseband symbol sent on subcarrier v∈{0, . . . , N−1} at OFDM symbol time n by node i. The OFDM modulator may perform an IFFT, producing the block of N time-domain “chips” xᵢ[n]=IFFT(Xᵢ[n])=(xᵢ[n,0], . . . , xᵢ[n,N−1]), where xᵢ[n,k] denotes the k-th chip of the n-th time-domain block. Each block xᵢ[n] may be cyclic-prefixed, forming xᵢ[n]=(\tilde{x}ᵢ[n,−L], . . . , \tilde{x}ᵢ[n,N−1]), where L denotes the length (in chips), of the cyclic prefix (CP). The sequence of cyclic-prefixed blocks may be sent to a digital-to-analog converter (DAC), forming the continuous-time complex baseband signal:

$${\tilde{x}}_{i} ( t ) = {\sum }_{n} {\sum }_{k = - L}^{N - 1} {\tilde{x}}_{i} [ n , k ] \prod ( ( t - {τ}_{i} ) / {T}_{s , i} - n ( N + L ) - k ) , \qquad ( 1 )$$

where Π(t) is the elementary interpolator DAC waveform. For simplicity, assume the brick-wall pulse:

$$\prod ( t ) = \{ \begin{matrix}1 & t ∈ [ - 1 / 2 , 1 / 2 ] \\ 0 & elsewhere\end{matrix} \qquad ( 2 )$$

The complex baseband signal may be modulated to the RF band, forming the carrier modulated signal:

sᵢ(t)=Re{\tilde{x}ᵢ(t)exp(j2πf_{0,i}t)}. (3)

Consider the corresponding receiver operations at node j. Let h_{i→j}(t) denote the complex baseband equivalent impulse response of the channel between i and j, including the receiver RF chain (LNA, analog-to-digital converter (ADC), anti-aliasing filter, etc.). In the absence of a CFO between i and j, and neglecting noise, the complex baseband received signal may be given by:

$$\begin{matrix}{\tilde{y}}_{i \to j} ( t ) = ( {h}_{i \to j} ⊗ {\tilde{x}}_{i} ) ( t + {τ}_{j} ) \\ = {\sum }_{n} {\sum }_{k = - L}^{N - 1} {\tilde{x}}_{i} [ n , k ] \int Π ( \begin{matrix}\frac{t + {τ}_{j} - u - {τ}_{i}}{{T}_{s , i}} - \\ n ( N + L ) - k\end{matrix} ) {h}_{i \to j} ( u ) d u \\ = {\sum }_{n} {\sum }_{k = - L}^{N - 1} {\tilde{x}}_{i} [ n , k ] {g}_{i \to j} ( t - ( {τ}_{i} - {τ}_{j} ) - ( n ( N + L ) + k ) {T}_{s , i} ) ,\end{matrix} \qquad ( 4 )$$

where g_{i→j}(t)=(Πᵢ [symbol] h_{i→j})(t) with Πᵢ(t)=Π(t/T_{s,i}) and (a [symbol] b)(t) denotes the continuous-time convolution of signals a(t) and b(t). Assume that the carrier frequency offset (CFO) |f_{0,i}−f_{0,j}| is sufficiently small such that the complex baseband signal after demodulation can be written as:

$${\tilde{y}}_{i \to j} ( t ) = ( {\sum }_{n} {\sum }_{k = - L}^{N - 1} {\tilde{x}}_{i} [ n , k ] {g}_{i \to j} ( t - ( {τ}_{i} - {τ}_{j} ) - ( n ( N + L ) + k ) {T}_{s , i} ) ) \times exp ( j2π ( {f}_{0 , i} - {f}_{0 , j} ) t ) . \qquad ( 5 )$$

Equation (5) may not hold in general, since the complex baseband equivalent channel impulse response may depend on the definition of the carrier frequency. However, when the CFO is much smaller than the signal bandwidth, (5) may be a good approximation. See T. M. Schmidl and D. C. Cox, “Robust frequency and timing synchronization for OFDM,” Communications, IEEE Transactions on, vol. 45, no. 12, pp. 1613-1621, December 1997, [Online], Available: http://dx.doi.org/10.1109/26.650240. The ADC at receiver j may produce samples at rate p/T_{s,j}, where p≧1 is a suitable oversampling integer factor. The resulting discrete-time complex baseband signal, may be given by:

$${\tilde{y}}_{i \to j} [ 𝓁 ] = ( {\sum }_{n} {\sum }_{k = - L}^{N - 1} {\tilde{x}}_{i} [ n , k ] {g}_{i \to j} ( 𝓁 {T}_{s , j} / p - ( {τ}_{i} - {τ}_{j} ) - ( n ( N + L ) + k ) {T}_{s , i} ) ) \times exp ( j2π ( {f}_{0 , i} - {f}_{0 , j} ) {T}_{s} 𝓁 / p ) . \qquad ( 6 )$$

Assume that T_{s,i} and T_{s,j} are very close to the nominal chip time Tₛ, as oscillator frequency may be on the order of a few parts per million (ppm). This may be equivalent to saying that over a single chip, the scale of the time axis at the two nodes is essentially identical, but accumulating over multiple OFDM symbols, there may be a timing misalignment that may depend linearly on the OFDM symbol. The discrete time index l may be decomposed as l=m(N+L)p+q, where q∈{−Lp, . . . , Np−1}. After extracting blocks of p(N+L) output samples, and assuming that |τᵢ−τⱼ|=TₛL, i.e., the absolute timing reference misalignment may be much less than the duration of a CP (the synchronization protocol that is proposed may make sure that this assumption is satisfied), it may arrive at the following channel model without inter-block interference (IBI), i.e., interference between consecutive OFDM symbols): for q∈{0, . . . pN−1}:

$${\tilde{y}}_{i \to j} [ m , q ] = ( {\sum }_{k = - L}^{N - 1} {\tilde{x}}_{i} [ m , k ] {g}_{i \to j} ( \begin{matrix}( q - kp ) {T}_{s} / p - ( {τ}_{i} - {τ}_{j} ) - \\ m ( N + L ) ( {T}_{s , i} - {T}_{s , j} )\end{matrix} ) ) \times exp ( j2π ( {f}_{0 , i} - {f}_{0 , j} ) {T}_{s} ( m ( N + L ) + q / p ) ) . \qquad ( 7 )$$

Because |f_{0,i}−f_{0,j}|Tₛ<<1, that is, the phase rotation across each OFDM symbol may be negligible, the dependence on q may be dropped from the argument of the exponential in (7). This is equivalent to approximating the instantaneous phase of the carrier term in (7) as piecewise constant on each OFDM symbol of duration (N+L)Tₛ, and taking into account only the phase increment in discrete steps from one OFDM symbol to the next. This approximation may be the time-domain equivalent of neglecting inter-carrier interference (ICI), which may be a valid approximation when the CFO is much smaller than the OFDM subcarrier separation.

Eventually, the received discrete-time mth signal block after CP removal may be given by:

$${\tilde{y}}_{i \to j} [ m , q ] \approx ( {\sum }_{k = - L}^{N - 1} {x}_{i} [ m , k mod N ] {g}_{i \to j} ( \begin{matrix}( q - kp ) {T}_{s} / p - ( {τ}_{i} - {τ}_{j} ) - \\ m ( N + L ) ( {T}_{s , i} - {T}_{s , j} )\end{matrix} ) ) \times exp ( j2π ( {f}_{0 , i} - {f}_{0 , j} ) {T}_{s} ( N + L ) m ) , \\ q = 0 , … , pN - 1. \qquad ( 8 )$$

The first term in the above product may be the cyclic convolution of the up-sampled sequence {xᵢ[m,k]:k=0, . . . , N−1} (with insertion of p−1 zeros in between each sample), with the discrete-time impulse response

g_{i→j}[m,q]=g_{i→j}(qTₛ/p−(τᵢ−τⱼ)−m(N+L)(T_{s,i}−T_{s,j})), q=0, . . . , pN−1. (9)

A frequency-domain representation of this cyclic convolution may be obtained. To this end, g_{i→j}[m,q] may be obtained by sampling at rate p/Tₛ the impulse response g_{i→j}(t) delayed by (τᵢ−τⱼ)+m(N+L)(T_{s,i}−T_{s,j}).

ξ∈[−½,½] may be used to denote the frequency variable for discrete-time signals, and f to denote the frequency variable for continuous-time signals. Defining the continuous-time Fourier transform:

G_{i→j}(f)=∫g_{i→j}(t)e^{-j2πft}dt, (10)

and using the time-shift property of the Fourier Transform and the known spectral folding relationship between continuous-time and discrete-time Fourier transforms, see R. Mudumbai, D. Brown, U. Madhow, and H. Poor, “Distributed transmit beamforming: challenges and recent progress,” Communications Magazine, IEEE, vol. 47, no. 2, pp. 102-110, february 2009, the discrete-time Fourier transform of g_{i→j}[m,q] may be given by:

$${G}_{i \to j} ( m , ξ ) = {\sum }_{q = 0}^{pN - 1} {g}_{i \to j} [ m , q ] {e}^{- j2πξ q} = \frac{p}{{T}_{s}} {\sum }_{𝓁} {G}_{i \to j} ( \frac{ξ - 𝓁}{{T}_{s} / p} ) \times exp ( - j2π ( ξ - 𝓁 ) \frac{( {τ}_{i} - {τ}_{j} ) + m ( N + L ) ( {T}_{s , i} - {T}_{s , j} )}{{T}_{s} / p} ) \qquad ( 11 )$$

Systems may be designed such N L 1 and the receiver sampling frequency p/Tₛ is large enough in order to avoid significant spectral folding. This may mean that only the term for l=0 is significant in the (discrete-time) frequency interval ξ∈[−1/(2 p),1/(2 p)], which is the interval of interest that contains the N OFDM subcarriers of the transmitted signal. Hence, after applying DFT and taking the samples corresponding to the set of discrete frequencies {v/(pN):v=−N/2, . . . , N/2−1}, and after some straightforward algebra (omitted for the sake of brevity) the OFDM frequency-domain demodulated signal is arrived at:

$$\begin{matrix} {Y}_{i \to j} [ m , v ] = {H}_{i \to j} [ v ] {X}_{i} [ m , v ] {\tilde{E}}_{i , j} [ m , v ] , & ( 12 ) \\ {H}_{i \to j} [ v ] = \frac{p}{{T}_{s , j}} {G}_{i \to j} ( \frac{v}{{NT}_{s}} ) , & ( 13 ) \\ {\tilde{E}}_{i , j} [ m , v ] = exp ( - j2π v \frac{( {τ}_{i} - {τ}_{j} )}{{NT}_{s}} ) \times exp ( - j2π vm \frac{( N + L ) ( {T}_{s , i} - {T}_{s , j} )}{{NT}_{s}} ) \times exp ( j2π ( {f}_{0. i} - {f}_{0 , j} ) {T}_{s} ( N + L ) m ) , & ( 14 )\end{matrix}$$

and where v∈{−N/12, . . . , N/2−1}. In equation (12), the term H_{i→j}[v]Xᵢ[m,v] is isolated. That may be expected for an ideal system, from the multiplicative error term \tilde{E}_{i,j}[m,v] induced by the TO, CFO and SFO.

At this point, a fundamental assumption may be made which is justified by the 802.11 standard, see, “Ieee standard for information technology—telecommunications and information exchange between systems local and metropolitan area networks—specific requirements part 11: Wireless Ian medium access control (mac) and physical layer (phy) specifications,” IEEE Std 802.11-2012 (Revision of IEEE Std 802.11-2007), pp. 1-2793, 29 2012: the sampling clock and the RF clock on each node hardware are derived from the same (local) oscillator, such that T_{s,i}f_{0,i}=k, a constant factor that depends only on the hardware design. Let f_{s,i}=fₛ+εᵢ, where fₛ is the nominal sampling frequency and εᵢ=fₛ is the sampling frequency offset (SFO) at node i. Hence, the normalized TO may be defined:

$$\frac{{τ}_{i}}{{T}_{s}} = {f}_{s} {τ}_{i} {=}^{Δ} {μ}_{i} , \qquad ( 15 )$$

the normalized SFO between nodes i and i:

$$\frac{( N + L ) ( {T}_{s , i} - {T}_{s , j} )}{{T}_{s}} = \frac{{f}_{s} ( N + L ) ( {ɛ}_{j} - {ɛ}_{i} )}{( {f}_{s} + {ɛ}_{i} ) ( {f}_{s} + {ɛ}_{j} )} \approx \frac{( N + L ) ( {ɛ}_{j} - {ɛ}_{i} )}{{f}_{s}} = {δ}_{j} - {δ}_{i} , \qquad ( 16 )$$

with δᵢ [symbol] (N+L)εᵢ/fₛ, and the normalized CFO between nodes i and j:

$$( N + L ) ( {f}_{0 , i} - {f}_{0 , j} ) {T}_{s} = \frac{κ ( N + L ) ( {ɛ}_{i} - {ɛ}_{j} )}{{f}_{s}} = {Δ}_{i} - {Δ}_{j} \qquad ( 17 )$$

with Δᵢ [symbol] κ(N+L)εᵢ/fₛ=κδᵢ. Finally, the multiplicative error term (14) may be expressed in terms of the normalized TO, SFO and CFO can be written as:

$${\tilde{E}}_{i , j} [ m , v ] = exp ( - j2π [ \frac{v}{N} ] ( {μ}_{i} - {μ}_{j} ) ) \times \\ exp ( j2π [ \frac{v}{N} ] ( {δ}_{i} - {δ}_{j} ) m ) \times ( 19 ) \\ exp ( j2π ( {Δ}_{i} - {Δ}_{j} ) m ) . ( 20 ) \qquad ( 18 )$$

with v∈{N/12, . . . , N/2−1}.

### Impact of Synchronization Errors on Distributed Multiuser MIMO

Consider a network formed by user nodes k=1, . . . , Nᵤ served in the downlink by APs i=1, . . . , Nₐ, using distributed MU-MIMO with linear zero-forcing beamforming (ZFBF), see G. Caire, N. Jindal, M. Kobayashi, and N. Ravindran, “Multiuser MIMO achievable rates with downlink training and channel state feedback,” IEEE Trans. Inf. Theory, vol. 56, no. 6, pp. 2845-2866, 2010. From the analysis developed above, the received signal 1×Nᵤ vector at the user receivers, at OFDM symbol m and subcarrier v, may be given by:

Y[m,v]=X[m,v]Φ[m,v]H[m,v]Θ[m,v]+Z[m,v], (21)

where H[m,v] is the Nₐ×Nᵤ channel matrix with (i,k)-th element H_{i,k}[m,v], X[m,v] is the 1×Nᵤ vector of frequency domain symbols transmitted by the Nᵤ APs simultaneously, and z[m,v] is the corresponding 1×Nᵤ vector of Gaussian noise samples, i.i.d.: CN(0,N₀). The two matrices Θ[m,v] and Φ[m,v] are diagonal of dimension Nᵤ×Nᵤ and Nₐ×Nₐ, respectively, with diagonal elements given by:

$$\begin{matrix}{θ}_{k , k} [ m , v ] = exp ( j2π [ \frac{v}{N} ] {\tilde{μ}}_{k} ) exp ( - j2π [ \frac{v}{N} ] {\tilde{δ}}_{k} m ) exp ( - j2π {\tilde{Δ}}_{k} m ) , \\ and & ( 22 ) \\ {φ}_{i , i} [ m , v ] = exp ( - j2π [ \frac{v}{N} ] {μ}_{i} ) exp ( j2π [ \frac{v}{N} ] {δ}_{i} m ) exp ( {j2πΔ}_{i} m ) . & ( 23 )\end{matrix}$$

While the effect of Θ[m,v] can be undone at each receiver by standard timing and frequency synchronization techniques suited to OFDM modulation, see M.-O. Pun, M. Morelli, and C.-C. Kuo, “Maximum-likelihood synchronization and channel estimation for ofdma uplink transmissions,” Communications, IEEE Transactions on, vol. 54, no. 4, pp. 726-736, april 2006; P. Moose, “A technique for orthogonal frequency division multiplexing frequency offset correction,” Communications, IEEE Transactions on, vol. 42, no. 10, pp. 2908-2914, oct 1994; T. M. Schmidl and D.C. Cox, “Robust frequency and timing synchronization for OFDM,” Communications, IEEE Transactions on, vol. 45, no. 12, pp. 1613-1621, December 1997, [Online], Available: http://dx.doi.org/10.1109/26.650240; F. Tufvesson, O. Edfors, and M. Faulkner, “Time and frequency synchronization for ofdm using pn-sequence preambles,” in Vehicular Technology Conference, 1999. VTC 1999—Fall. IEEE VTS 50th, vol. 4, 1999, pp. 2203-2207 vol. 4; J.-J. van de Beek, M. Sandell, M. Isaksson, and P. Ola Borjesson, “Low-complex frame synchronization in ofdm systems,” in Universal Personal Communications. 1995. Record., 1995 Fourth IEEE International Conference on, nov 1995, pp. 982-986, the presence of Φ[m,v] in between the precoded transmit vector x[m,v] and the channel matrix H[m,v] may yield a degradation of ZFBF. The ZFBF precoding matrix may be calculated based on an estimate of the “nominal” channel matrix H[0,v], at the beginning of the preceding block (here indicated as OFDM symbol m=0), but is ignorant of the matrix Φ[m,v] unless TO, SFO and CFO are explicitly taken into account and compensated.

The synchronization protocol may be examined by the performance degradation due to typical uncompensated SFO and CFO between the APs. An achievable rate lower bounds may be obtained assuming an i.i.d. equal-power Gaussian coding ensemble, where the users treat the residual interference due to imperfect zero-forcing as noise. Assume downlink blocks of M=60 OFDM symbols, typical of 802.11, see “Ieee standard for information technology—telecommunications and information exchange between systems local and metropolitan area networks—specific requirements part 11: Wireless Ian medium access control (mac) and physical layer (phy) specifications,” IEEE Std 802.11-2012 (Revision of IEEE Std 802.11-2007), pp. 1-2793, 29 2012, assume H[m,v] constant with respect to the time index m=0, . . . , M−1 over each block and, optimistically, assume ideal TDD reciprocity and noiseless uplink channel estimation through uplink pilot symbols. Provided that the relative TO between APs is within the length of the CP, the terms

$$exp ( - j2π [ \frac{v}{N} ] {μ}_{i} )$$

are automatically included as part of the channel estimated from the uplink pilot symbols. Under these assumptions, the CS may compute the zero-forcing precoder as the row-normalized left pseudo-inverse of the matrix Φ[0, v]H[0,v] (see, G. Caire, N. Jindal, M. Kobayashi, and N. Ravindran, “Multiuser MIMO achievable rates with downlink training and channel state feedback,” IEEE Trans. Inf. Theory, vol. 56, no. 6, pp. 2845-2866, 2010), and uses this precoder throughout the whole downlink block of length M symbols. Because of the phase rotations introduced by the (time-varying) matrix Φ[m,v], the precoder may be mismatched for m>0 and the performance may severely degrade because of the residual multiuser interference.

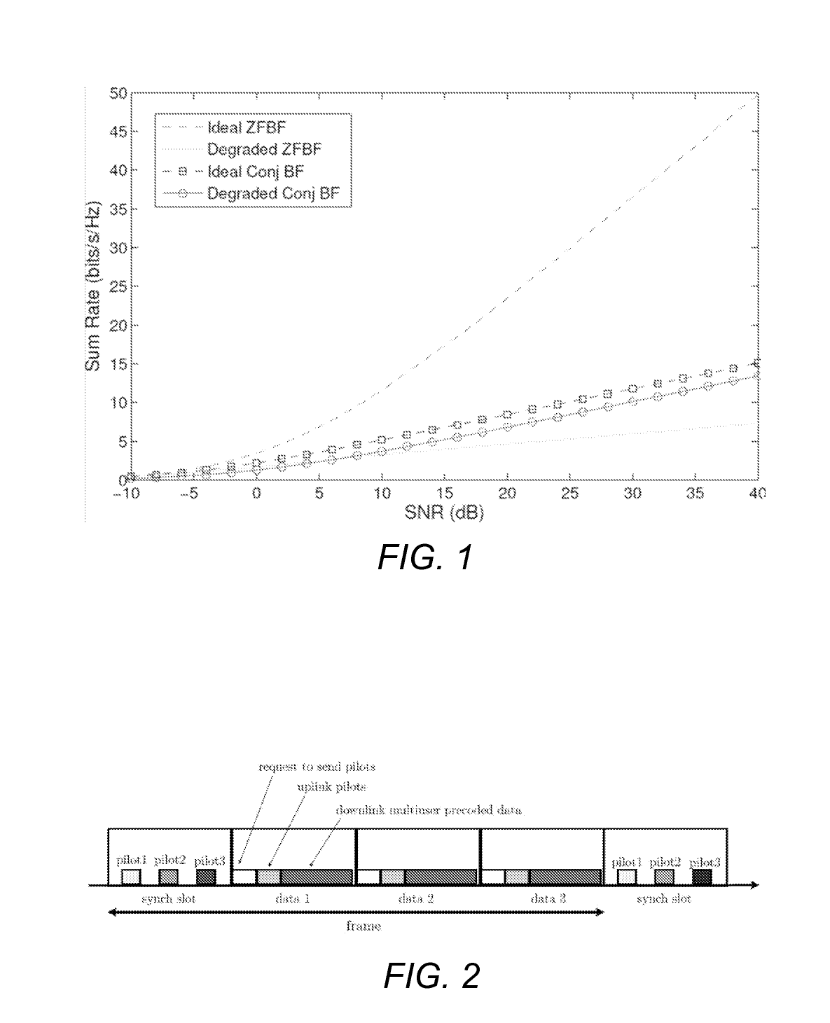

FIG. 1 illustrates an example of achievable rates for a 4×4 distributed MU-MIMO systems with synchronization impairments. The achievable rates were obtained by Monte Carlo simulation assuming H[0,v] with i.i.d. elements CN(0,1) (normalized independent Rayleigh fading) of a 4×4 network (Nₐ=Nᵤ=4), εᵢ i.i.d. across the users and the downlink blocks, uniform over [−εₘₐₓ,εₘₐₓ], with εₘₐₓ=20×10⁻⁶ (20 ppm), from the 802.11 specification, see “Ieee standard for information technology—telecommunications and information exchange between systems local and metropolitan area networks—specific requirements part 11: Wireless Ian medium access control (mac) and physical layer (phy) specifications,” IEEE Std 802.11-2012 (Revision of IEEE Std 802.11-2007), pp. 1-2793, 29 2012. The OFDM modulation has parameters N=64 and L=16. The achievable rate shown here is an average rate across the block. Since the system may lose synchronism progressively across each block, the achievable rate may rapidly degrade as the OFDM symbol m increases, such that the average performance may be quite poor. As a comparison, it also shows the performance for a corresponding ideal system without CFO and SFO (i.e., average rate at m=0 only), and the performance of a single-user distributed beamforming scheme (conjugate beamforming, see C. Shepard, H. Yu, N. Anand, E. Li, T. Marzetta, R. Yang, and L. Zhong, “Argos: practical many-antenna base stations,” in Proceedings of the 18th annual international conference on Mobile computing and networking, ser. Mobicom '12. 1 em plus 0.5 em minus 0.4 em New York, N.Y., USA: ACM, 2012, pp. 53-64, [Online], Available: http://doi.acm.org/10.1145/2348543.2348553; R. Mudumbai, D. Brown, U. Madhow, and H. Poor, “Distributed transmit beamforming: challenges and recent progress,” Communications Magazine, IEEE, vol. 47, no. 2, pp. 102-110, february 2009) with and without CFO and SFO. Single-user beamforming may suffer much less from the lack of synchronization, and may significantly outperform ZFBF at high SNR. Thus, the technology may provide the transmitters with sufficient synchronization such that the higher spectral efficiency promised by distributed MU-MIMO is effectively realized in practice.

### System Architecture

This section provides an example of high-level system architecture and underlying system assumptions. Details of example synchronization algorithms are given below. This section discussed the problem of joint TO and CFO estimation through a multi path channel with known delays and unknown channel coefficients. Timing and frequency estimation may be a building block for the synchronization protocol discussed above, which can be applied to a wide range of estimators (not necessarily joint-ML as now explained).

The network may undergo a setup phase in which each AP discovers its neighbor APs and measures the associated propagation delays. Synchronization may track the variations of the oscillator frequency. The frequency uncertainty εᵢ may be modeled as an unknown constant. In reality, this may depend on temperature, and may fluctuate around its nominal 0 value with a typical coherence time on the order of 1 s. Furthermore, since the SFO and CFO are estimated up to some error, the residual drift due to non-ideal compensation may require that the synchronization protocol is repeated sufficiently frequently such that the errors do not accumulate significantly over the downlink blocks.

FIG. 2 illustrates an example of a frame structure of a distributed MU-MIMO architecture. The sync slot may contain several pilot signals, orthogonal in time, and separated by guard intervals, which may be assigned to the anchor APs according to a graph coloring scheme. In this example, there are three orthogonal pilot signals, indicated by three different shades of grey, and the frame length is four slots.

The protocol may make use of a frame structure formed by synchronization and downlink data slots as shown in FIG. 2. The duty cycle of the synchronization slots may be determined by the quality of the synchronization, which may be dependent upon the SNR between APs.

Let T={i: i=1, . . . , Nₐ} denote the set of APs. It may be defined as a directed network graph with vertices T and edges E={(i, j)} for all ordered pairs of APs i,j such that the SNR of the transmission i→j is above some suitably defined threshold. Because of TDD reciprocity, if (i,j)∈E then (j,i) is also in E. Without loss of generality, it is assumed that the graph (T,E) is connected. (Otherwise, the same algorithms may be applied independently on each connected components.) A⊂T defines a connected cover, see Z. Zhang, X. Gao, and W. Wu, “Algorithms for connected set cover problem and fault-tolerant connected set cover problem,” Theoretical Computer Science, vol. 410, no. 8ââ, [symbol] “10, pp. 812-817, 2009. [Online]. Available: http://www.sciencedirect.com/science/article/pii/S0304397508008554, i.e., a set of APs forming a connected subgraph, and such that any other AP has at least one neighbor in A. The APs in A are referred to as “anchor” nodes. E(A) denotes the subset of edges involving nodes in A only, therefore the connected cover is the subgraph (A, E(A)).

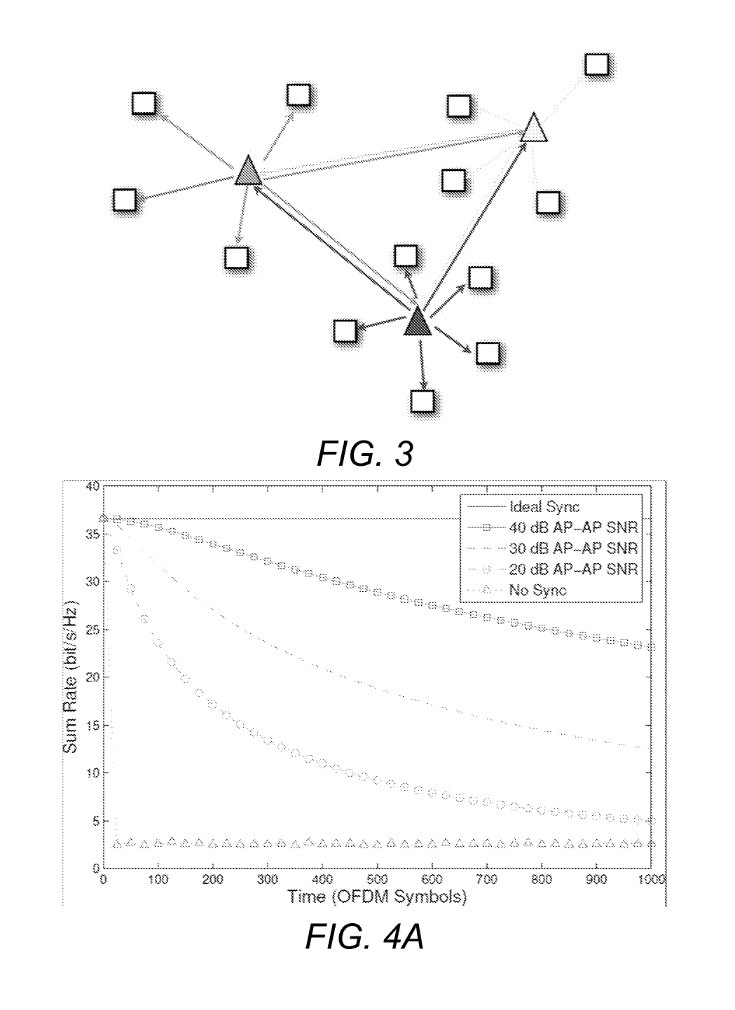

FIG. 3 illustrates an example of a network graph with three anchor nodes (triangles) making use of different pilot bursts. The non-anchor APs may not transmit pilots, and may listen to their neighbor anchor node pilot burst in order to correct their timing and frequency reference.

For example, FIG. 3 shows a network with three clusters and one anchor node per cluster. Each cluster might be inside a building and the anchor node may be selected to be APs in special positions (e.g., roof-top) such that they can exploit some line-of-sight propagation. It may be part of the network deployment phase to define an appropriate set of anchor APs. In addition, some self-organizing algorithm may be designed to find a good set without centralized planning.

The synchronization slots may be formed by a number of pilot bursts (sequences of time-domain chips) separated by guard intervals. It is assumed that the chromatic number χ of the connected cover is not larger than the number of distinct pilots bursts in the synchronization slot. Hence, it is possible to assign a pilot burst to each anchor node such that no two neighbor anchor nodes share the same pilot. In this way, each anchor node can receive all pilot bursts from its anchor neighbors, and they may be mutually orthogonal in time. The non-anchor APs in T-A may not transmit pilot bursts, and just listen to one or more pilot bursts from its neighbor anchor nodes. Eventually, at the end of a synchronization slot, each anchor node has received orthogonal pilots from all its neighbors. These measurements may be sent through the wired backhaul network to the CS, which computes correction factors for synchronization.

A rough timing synchronization may be provided through the wired backhaul network using a coarse frame synchronization protocol such as IEEE 1588, see “Ieee standard for a precision clock synchronization protocol for networked measurement and control systems,” IEEE Std 1588-2008 (Revision of IEEE Std 1588-2002), pp. c1-269, 24 2008. As a result, each AP may know where to look for the pilot bursts up to an accuracy of a few OFDM symbols, corresponding to the guard intervals inserted between the pilot bursts. After the synchronization slot and the centralized computation of the timing and frequency correction factors, the APs may be time/frequency synchronous and can perform (up to residual errors) as a single, distributed multi-antenna AP. This synchronization may be maintained over the data transmission slots in the frame, until the next synchronization slot.

The data slots, in the spirit of an 802.11-like system, may be arranged as follows: in each slot, the APs send a request for uplink pilots to be sent by the users. The users decode this request to send, and the users which have been requested respond with their uplink pilots. In the simplest case, it can be assumed that the users send pilots orthogonal in time, similar to the 802.11ac specification, see “IEEE Draft Standard for IT—Telecommunications and Information Exchange Between Systems—LAN/MAN—Specific Requirements—Part 11: Wireless LAN Medium Access Control and Physical Layer Specifications—Amd 4: Enhancements for Very High Throughput for operation in bands below 6 GHz,” IEEE P802.11ac/D3.0, June 2012, pp. 1-385, 11 2012, though more intelligent schemes might utilize some form of frequency reuse. The users may acquire timing and frequency from the request to send, and therefore their pilots may be nearly timing (within a CP) and frequency synchronous, since they respond immediately and there may be no time for the drifts to be significant. After receiving the uplink pilots, the APs may send the estimated channels to the CS, which may compute the downlink precoded signals (baseband samples) and send them to the APs for downlink MU-MIMO precoding (e.g., ZFBF).

### Synchronization

In order to overcome the impairments discussed herein, effects of the error term (23) may be undone by each AP i transmitter by multiplying the transmitted frequency domain symbols Xᵢ[m,v] by the time and frequency dependent phase rotation factor:

$${P}_{i} [ m , v ] = exp ( - j2π ( 1 + \frac{1}{κ} [ \frac{v}{N} ] ) {Δ}_{i}^{corr} m ) , \qquad ( 24 )$$

and by adjusting the timing reference (origin of the transmitter time axis) by μᵢ^{corr}. The timing and frequency corrections Δᵢ^{corr}, μᵢ^{corr} are provided by the CS through a simple (low-complexity) centralized computation.

In addition to the baseband symbol rotation, the SFO may produce a contraction or dilation of the time axis of each AP. While this may be a negligible effect over a few tens of OFDM symbols (typical duration of a data slot), it can accumulate over the slots such that at some point the TO between different APs becomes larger than the OFDM CP. If not corrected, eventually the resulting IBI may produce unacceptable performance degradation. This problem may be overcome by periodically repeating or skipping a sample, such that each AP stays sample-synchronous over a long period of time. For example, if it is known that one AP's sampling clock is 1% faster than the common sampling frequency dictated by the CS, then this AP may repeat a sample every 100 samples. In order to implement this sample skipping correction scheme each AP may need to know the multiplicative SFO (e.g., that one clock is 1% faster), with respect to a common sampling frequency. However, the APs may only be capable of measuring frequency differences.

The same symbol rotation by the quantity in (24) may be applied to signals received at the APs during the uplink training from the users, in the data slots. In this way, all APs may use the same time and frequency reference for the calculation of the downlink channel matrix for MU-MIMO precoding.

### Least-Squares Synchronization

After each synchronization slot, each anchor node may collect pilot bursts from all of its neighbor anchor nodes, and produce an estimate of the TO and CFO with respect to its neighbors, by using any suitable timing and frequency estimation technique. It may focus only on the anchor nodes, since the non-anchor APs may obtain their correction factor directly by measuring their TO and CFO with respect to their neighboring anchor node(s). Presented herein is the derivation of the Cramer-Rao bound and of the joint ML timing and frequency estimator in the case where the multipath channel impulse response has known delays and unknown path coefficients. This may be motivated by the fact that the delays between APs, which do not move, may accurately be estimated during the network setup phase and updated on a very slow time-scale, while the channel coefficients typically undergo faster statistical fluctuations even though the relative position of the APs doesn't change. Therefore, it may make sense to treat these coefficients as unknown. In the results, the CRB may be used as a proxy for the timing and frequency estimation MSE, as a function of the channel SNR and impulse response. This is done here for analytical convenience, and it is motivated by the fact that, in the range of channel SNR of interest for WLAN applications, the proposed joint ML estimator yields MSE almost identical to the CRB. In practice, the MSE of the actual estimator used in a specific implementation may be evaluated.

After estimation, the anchor AP i may produce the CFO and TO (noisy) estimates:

[symbol]

_{j→i}=Δⱼ−Δᵢ+z_{j→i}, (25)

and

[symbol]

_{j→i}=μⱼ−μᵢ+w_{j→i}, (26)

for all j∈A(i), where A(i) denotes the neighborhood of node i in the anchor set A, and where z_{j→i} and w_{j→l} are estimation errors, modeled as i.i.d. Gaussian random variables with variance that is given by the estimation MSE.

Each node i∈A may send via the wired backhaul its estimates { [symbol] _{j→i}:j∈A(i)} and { [symbol] _{j→i}:j∈A(i)} to the CS. The latter may compute the correction terms Δᵢ^{corr}, μᵢ^{corr} by exploiting all these estimates. The absence of estimation errors would have [symbol] _{j→i}=Δⱼ−Δᵢ. It therefore may make sense to solve for the carrier frequencies by minimizing the LS cost function:

$${J}_{Δ} ( {Δ}_{1} , … , {Δ}_{\vert A \vert} ) = {\sum }_{( j , i ) ∈ E ( A )} {( {\hat{δΔ}}_{j \to i} - ( {Δ}_{j} - {Δ}_{i} ) )}^{2} . \qquad ( 27 )$$

If the estimation noise random variables z_{j→i} are effectively Gaussian i.i.d., then the minimizer of (27) may be the ML joint estimator based on the observations (25). As already noticed, because of TDD reciprocity, if j∈A(i) then i∈A(j). Therefore, measurements may always come in pairs.

Taking the partial derivative with respect to and setting it equal to zero, the following set of linear equations may be obtained:

$${\sum }_{j ∈ A ( i )} ( {Δ}_{i} - {Δ}_{j} ) = \frac{1}{2} {\sum }_{j ∈ A ( i )} ( {\hat{δΔ}}_{i \to j} - {\hat{δΔ}}_{j \to i} ) , \qquad ( 28 )$$

that can be collected in matrix form as:

LΔ=u, (29)

where L is the Laplacian matrix of the estimation connectivity graph of (A, E(A)) (The connectivity graph of the directed graph (A, E(A)) is the undirected graph with nodes A and edges connecting i,j whenever (i,j),(j,i)∈E (A). The Laplacian matrix is the |A|×|A| matrix with elements −1 in positions corresponding to i,j whenever these nodes are connected, element |A(i)| (the degree of i) in the diagonal position corresponding to node i and zero elsewhere.) where Δ=(Δ₁, . . . , Δ_{|A|})^{T} and u is the |A|×1 vector with element ½Σ_{j∈A(i)} [symbol] _{i→j}− [symbol] _{j→i}) in the position corresponding to node i.

L may have a rank |A|−1 and the system of equations (29) may be under-determined. In fact, L1=0 (1 being the all-one vector). It may follow that, for any vector Δ, solving (29) and any constant Δ^{ref}, then Δ−Δ^{ref} 1 may also be a solution. This may be expected, since only frequency differences can be observed. In order to find a solution, choose a reference anchor AP, without loss of generality indexed by 1, and define the frequency difference vector \tilde{Δ} with elements \tilde{Δ}ᵢ=Δᵢ−Δ₁ for all i∈A with i≠1. The new system of equations involving \tilde{Δ} may be given by \tilde{L}\tilde{Δ}=u, where \tilde{L} is obtained from L by eliminating the first column. The sought solution may be given by:

\tilde{Δ}=(\tilde{L}^{T}\tilde{L})⁻¹\tilde{L}^{T}u. (30)

The correction factor Δᵢ^{corr} may be equal to 0 for i=1 (reference anchor AP) and given by:

Δᵢ^{corr}=\tilde{Δ}ₗ

for i≠1.

Notice that, if f_{0,1} coincides with the nominal carrier frequency f₀, then \tilde{Δ}ᵢ may represent an estimate of the CFO of node i with respect to the nominal carrier frequency, namely, an estimate of ice, according to the model and definitions discussed hereon. Hence, it may be sufficient to include in the network one anchor AP with a very precise oscillator (e.g., an expensive oven-controlled oscillator), and let this node be 1, a reference anchor AP, in order to “transfer” its precision to all other APs in the network. If the number of APs in the network is very large, the marginal cost of one expensive oscillator may be negligible.

As far as the TO estimation is concerned, define the LS cost function:

$${J}_{μ} ( {μ}_{1} , … , {μ}_{\vert A \vert} ) = {\sum }_{( j , i ) ∈ E ( A )} {( {\hat{δμ}}_{j \to i} - ( {μ}_{j} - {μ}_{i} ) )}^{2} \qquad ( 31 )$$

and the problem may be completely isomorphic to the CFO problem. Hence, following in the footsteps of what was done before, the timing correction factors μᵢ^{corr} can be determined relative to the reference anchor AP 1.

As a general guideline for the duration over which the synchronization holds, the same example discussed above is explored in which there is a 4×4 system, which may now be synchronized through the centralized LS approach. The variance of the estimation noise for TO and CFO may be given by the CRB derived above, which may be very close to the MSE achieved by joint ML estimation for appropriately designed pilot bursts (see Section 3).

FIGS. 4A and 4B illustrate an example of achievable rates versus time of a 4×4 system after synchronization. FIG. 4A illustrates how varying the SNR between APs may affect the quality of the synchronization, and thus the resulting rate to the users. FIG. 4B shows how the same quantity may be impacted by the training sequence length.

FIGS. 4A and 4B show the achievable rate versus the index of the OFDM symbol for the case where the channel matrix is perfectly known at time m=0 and the ZFBF precoder is calculated at time 0 and kept constant throughout the block. Differently from the results of FIG. 1, obtained for free-running oscillators, it is assumed that at time 0 the CFO is estimated according to the LS scheme discussed above and the phase rotation factor (24) is applied throughout the sequence of OFDM symbols. In these results, it is assumed that all four APs are anchor nodes, in line-of-sight of each other (the channel is formed by a single path with an unknown but constant channel coefficient), and the same SNR on each channel. It is also assumed that the SNR for the AP-to-user channels is constant at 30 dB. For the pilot bursts, the structure formed by N_{c}/4 random QAM time-domain chips is used, followed by N_{c}/2 zeros and a repetition of the same N_{c}/4 QAM chips, as described in the numerical example above, for which the joint maximum likelihood estimator very closely achieves the Cramer-Rao Bound. In FIG. 4A, the sequence length constant at N_{c}=256 is held while varying the SNR between APs, illustrating how the quality of synchronization is linked to the SNR of the channel during the pilot exchange. In FIG. 4B, the AP-to-AP SNR constant is held at 30 dB while varying the sequence length.

### Sample-Skipping

It was shown before that Δᵢ^{corr} may be a good estimate of the (normalized) CFO between the carrier frequency of AP i and the nominal carrier frequency, provided that there exists a reference anchor AP equipped with a good quality oscillator. Under this assumption, let

$${Δ}_{i}^{corr} \approx \frac{{κɛ}_{i} ( N + L )}{{f}_{s}} ,$$

such that:

$${f}_{s , i} = {f}_{s} + {ɛ}_{i} \approx {f}_{s} ( 1 + \frac{{Δ}_{i}^{corr}}{κ ( N + L )} ) .$$

This yields, with good approximation, the multiplicative SFO factor equal to:

$$1 + \frac{{Δ}_{i}^{corr}}{κ ( N + L )} .$$

Applying this approximation to the previous 4×4 system, the time it takes until the approximation causes a timing error (i.e., when two APs become more than a cyclic prefix out of sync) may be investigated. Even though the above approximation is derived under the assumption of a very accurate oscillator in one of the nodes, this scenario may be explored assuming 802.11 compliant (20 ppm) oscillators. Use an AP-to-AP SNR of 20 dB, and assume that the channel impulse response is a single unknown tap, as in the previous case. Further, the MSE may ne generated by a sequence of 64 QPSK symbols, followed by 128 zeros, followed by the same 64 QPSK symbols (the N_{c}=256 case, as above).

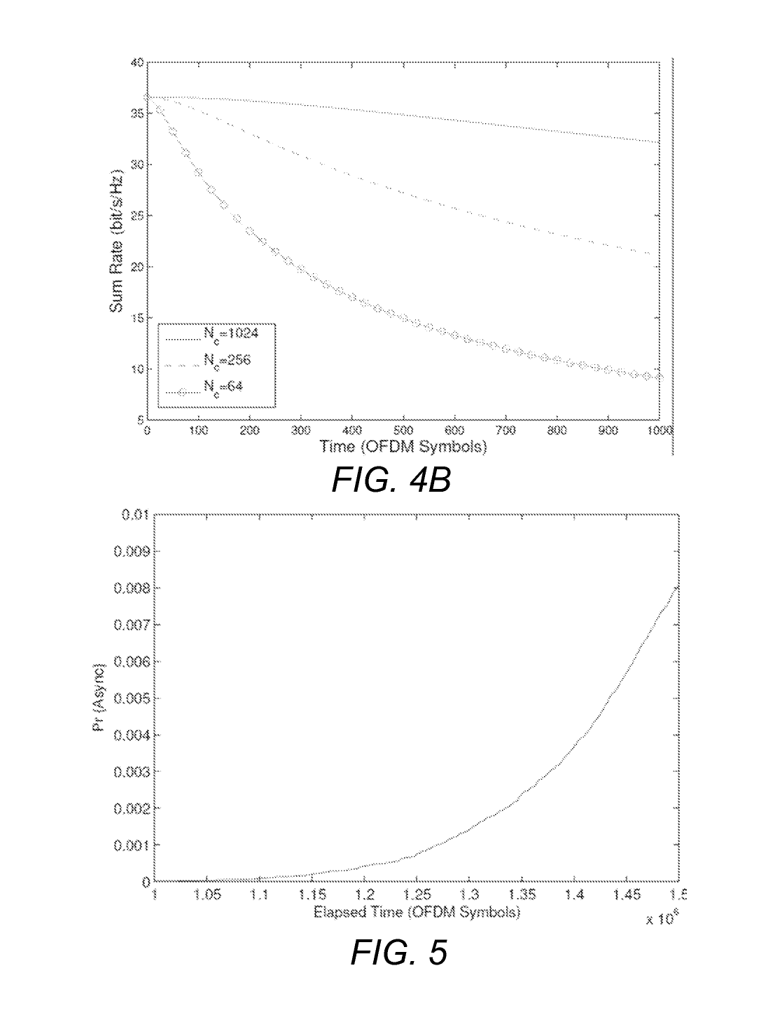

FIG. 5 illustrates an example of a CDF of a time-to-asynchronism (time until two APs are more than a CP asynchronous) of an imperfect sample skipping mechanism. The parameters used for the CP length and oscillator accuracy are taken from the 802.11 specification.

FIG. 5 illustrates that, even after a time on the order of 10⁶ OFDM symbols, the probability of becoming asynchronous may still be less than 10⁻³. As a result, the approximation utilized above may be sufficiently accurate.

### Timing and Frequency Joint ML Estimation

This section focuses on the estimation of the TO and CFO between a transmitter and a receiver, connected via a multi-path locally linear time-invariant additive white Gaussian noise channel with known path delays and unknown path coefficients. As explained in the system architecture above, this estimator may be used at each AP to produce estimates of the type (25) and (26), and may represent the fundamental building block for the synchronization protocol. Here, for the sake of notation simplicity, the nodes indices are neglected and the perspective is that of the receiver. The timing and carrier frequency differences between the transmitter and the receiver are denote by δτ and by δf, whose goal consists of estimating δτ and δf from the reception of the noisy pilot burst sent by the transmitter.

This problem has been treated in the framework of OFDM, see M.-O. Pun, M. Morelli, and C.-C. Kuo, “Maximum-likelihood synchronization and channel estimation for ofdma uplink transmissions,” Communications, IEEE Transactions on, vol. 54, no. 4, pp. 726-736, april 2006; P. Moose, “A technique for orthogonal frequency division multiplexing frequency offset correction,” Communications, IEEE Transactions on, vol. 42, no. 10, pp. 2908-2914, October 1994; T. M. Schmidl and D. C. Cox, “Robust frequency and timing synchronization for OFDM,” Communications, IEEE Transactions on, vol. 45, no. 12, pp. 1613-1621, December 1997, [Online], Available: http://dx.doi.org/10.1109/26.650240; F. Tufvesson, O. Edfors, and M. Faulkner, “Time and frequency synchronization for ofdm using pn-sequence preambles,” in Vehicular Technology Conference, 1999. VTC 1999—Fall. IEEE VTS 50th, vol. 4, 1999, pp. 2203-2207 vol. 4; J.-J. van de Beek, M. Sandell, M. Isaksson, and P. Ola Borjesson, “Low-complex frame synchronization in ofdm systems,” in Universal Personal Communications. 1995. Record., 1995 Fourth IEEE International Conference on, November 1995, pp. 982-986. Here, the focus is on joint ML estimation for an arbitrary pilot signal, calculate the Cramer-Rao bound (CRB), and compare different pilot signal designs on the basis of their CRB. The joint ML estimator is derived and shown that, for suitably designed pilot signals, the estimation MSE resulting from the joint ML estimator essentially coincides with the CRB for a wide range of the channel SNR. Therefore, this motivates the use of CRB as a proxy of the actual estimator MSE when evaluating the performance of the LS-based synchronization scheme.

The received time-domain baseband signal corresponding to a pilot transmission may be given by:

$$y ( t ) = ( {\sum }_{p = 0}^{P - 1} {c}_{p} s ( t - δ τ - {ρ}_{p} ) ) {e}^{j2πδ ft} + z ( t ) \qquad ( 32 )$$

where, assume an unknown multi path channel with impulse response:

$$\begin{matrix}h ( t ) = {\sum }_{p = 0}^{P - 1} {c}_{p} δ ( t - {ρ}_{p} ) , \\ Where \text{:} & \\ s ( t ) = \frac{1}{\sqrt{{T}_{s}}} {\sum }_{n = 0}^{{N}_{c} - 1} {s}_{n} Π ( t / {T}_{s} - n ) & ( 33 )\end{matrix}$$

is the pilot signal, defined by the sequence of time-domain chip symbols s=(s₁, . . . , s_{N}_{_{c}}) linearly modulating the chip pulse Π(t), defined in (2). The factor 1/\sqrt{Tₛ} is included such that the chip pulse has unit energy. In (32), z(t) denotes the complex circularly-symmetric Gaussian white noise, with autocorrelation function E[z(t)z*(t−τ)]=N₀δ(τ).

Over the short duration of the pilot burst, the difference in sampling clocks between transmitter and receiver may be negligible and the accumulated timing drift may be automatically included into the timing difference δτ. Therefore, Tₛ may be used as the common nominal sampling interval for the DAC at the transmitter and the ADC at the receiver. Letting T(t)=(Π [symbol] Π)(t) and assuming that the receiver performs chip matched filtering and sampling with one sample per chip, the received discrete-time observation may be obtained:

$$y [ m ] = ( {\sum }_{p = 0}^{P - 1} {c}_{p} {\sum }_{n = 0}^{{N}_{c} - 1} {s}_{n} T ( m - n - \frac{δ τ + {ρ}_{p}}{{T}_{s}} ) ) {e}^{j 2 π δ {fT}_{s} m} + z [ m ] \qquad ( 34 )$$

where z[m] is a discrete-time complex circularly symmetric i.i.d. Gaussian process with z[m]: CN(0,N₀)

The receiver may have a coarse knowledge of the super-frame timing (obtained from the CS via the wired backhaul), such that it expects to find the pilot burst in a given interval including the guard times around it (see above). Assume that the receiver collects M samples, for some value M such that MTₛ spans the interval in which the receiver expects to find the pilot burst. Z convenient vector expression may be obtained for the observation by collecting the M samples y[m] into an M×1 vector y=(y[0], . . . , y[M−1])^{T}, defining δξ=δfTₛ, (this is related to Δᵢ−Δⱼ as defined in (17) by

$$δξ = \frac{{Δ}_{i} - {Δ}_{j}}{N + L} ,$$

when i is the transmitter and j the receiver) letting δμ=δτ/Tₛ, consistently with the difference μᵢ−μⱼ as defined before (see (15)), defining the diagonal matrix:

Ξ(δξ)=diag(1,e^{j2πδξ},e^{j4πδξ}, . . . ,e^{j2πδξ(M-1)}),

the M×(M−N_{c}+1) convolution matrix (tall Toeplitz matrix):

$$S = [ \begin{matrix}{s}_{0} & 0 & … & & & 0 \\ {s}_{1} & {s}_{0} & & & & ⋮ \\ ⋮ & & ⋱ & & & \\ {s}_{{N}_{c} - 1} & & & & & ⋮ \\ 0 & ⋱ & & & & {s}_{0} \\ ⋮ & & & & & ⋮ \\ 0 & … & & & & {s}_{{N}_{c} - 1}\end{matrix} ]$$

and the matrix T(δμ) of dimension (M−N_{c}+1)×P whose p-th column (for p=0, . . . , P−1) has entries:

T(l−δμ−ρₚ/Tₛ), for l=0, . . . , M−N_{c}.

The discrete-time sampled version of the convolution (T [symbol] h)(t) may simply be given by the product T(δμ)c, where c=(c₀, . . . , c_{P-1})^{T} is the vector of path coefficients. Eventually, this can be written:

y=Γ(δξ,δμ)c+z, (35)

where Γ(δξ,δμ)=Ξ(δξ)ST(δμ) and z=(z[0], . . . , z[M−1])^{T}.

By construction, each column of T(δμ) may have at most two adjacent elements different from zero, namely, for the components l such that |l−δμ−ρₚ/Tₛ|≦1, i.e., for:

l=+└δμ+ρₚ/Tₛ┘

and for:

l=±└δμ+ρₚ/Tₛ┘+1.

The corresponding non-zero samples may be given by:

Tₚ⁻(δμ)=1−|└δμ+ρₚ/Tₛ┘−δμ−ρₚ/Tₛ|

and by:

Tₚ⁺(δμ)=1−|└δμ+ρₚ/Tₛ┘−δμ−ρₚ/Tₛ+1|.

The joint ML estimator for δξ, δμ and c, assuming N₀ and {ρₚ} known, is obtained by maximizing the Likelihood Function:

$$Λ ( δξ , δμ , c ) = \frac{1}{{( π {N}_{0} )}^{M}} exp ( - \frac{1}{{N}_{0}} {‖ y = Γ ( δξ , δμ ) c ‖}^{2} ) . \qquad ( 36 )$$

This may be equivalent to minimize the square distance ∥y−Λ(δξ,δμ)c∥². For given δξ and δμ, the minimization with respect to c may yield:

ĉ=(Γ^{H}(δξ,δμ)Γ(δξ,δμ))⁻¹Γ^{H}(δξ,δμ)y.

Replacing this into the objective function, after some simple algebra, the maximization of the Likelihood Function may be found to be equivalent to maximizing with respect to δξ and δμ the quadratic form:

F(δξ,δμ)=y^{H}Γ(δξ,δμ)(Γ^{H}(δξ,δμ)Γ(δξ,δμ))⁻¹Γ^{H}(δξ,δμ)y. (37)

This can be interpreted as maximizing the energy of the projection Y onto the column space of the signal matrix Λ(δξ,δμ). At this point, the joint ML estimator may be obtained by searching over a two-dimensional sufficiently fine grid of points with respect to the variables δξ and δμ.

Next, the CRB for this estimation problem may be derived. When the likelihood function is a multivariate Gaussian CN(m(θ),Σ) with the dependence on the parameters in the mean, then the Fisher information matrix J(θ) may have (a,b) elements, see S. M. Kay, Fundamentals of Statistical Signal Processing: Estimation Theory. 1 em plus 0.5 em minus 0.4 em Englewood Cliffs, N.J.: Prentice Hall, 1993:

$${J}_{a , b} ( θ ) = 2 Re \{ {( \frac{\partial m ( θ )}{\partial {θ}_{a}} )}^{H} {Σ}^{- 1} \frac{\partial m ( θ )}{\partial {θ}_{b}} \} .$$

In this case, Σ=N₀I, m(θ)=Ξ(δξ)ST(δμ)c, and the vector of parameters θ may have elements:

θ₁=δξ, θ₂=δμ, θ₂ₚ₊₃=Re{cₚ}, θ₂ₚ₊₄=Im{cₚ}, p=0, . . . , P−1.

Define D=diag (0, 1, . . . , M−1) and let eₚ denote P×1 vector with all zeros and a single 1 in position p, for p=1, . . . , P. Also let T′(δμ) denote the derivative of T(δμ) with respect to δμ, whose p-th column has only two non-zero elements equal to −1 at component l=└δμ+ρₚ/Tₛ ┘ and equal to +1 at component l=└δμ+ρₚ/Tₛ┘+1. Then:

$$\begin{matrix}\frac{\partial m ( θ )}{\partial δξ} = j2π D Ξ ( δξ ) ST ( δ μ ) c , & ( 38 ) \\ \frac{\partial m ( θ )}{\partial δξ} = Ξ ( δξ ) {ST}^{′} ( δ μ ) c , & ( 39 ) \\ \frac{\partial m ( θ )}{\partial Re \{ {c}_{p} \} } = Ξ ( δξ ) ST ( δ μ ) {e}_{p} , & ( 40 ) \\ \frac{\partial m ( θ )}{\partial Im \{ {c}_{p} \}} = j Ξ ( δξ ) ST ( δ μ ) {e}_{p} . & ( 41 )\end{matrix}$$

Next, form the matrix K whose a-th column is

$$\frac{\partial m ( θ )}{\partial {θ}_{a}} ,$$

such that the Fisher information matrix is obtained as:

$$J ( θ ) = \frac{2}{{N}_{0}} Re \{ {K}^{H} K \} . \qquad ( 42 )$$

Eventually, the CRB for δξ and δμ may be obtained by the first two diagonal elements of J⁻¹(θ).

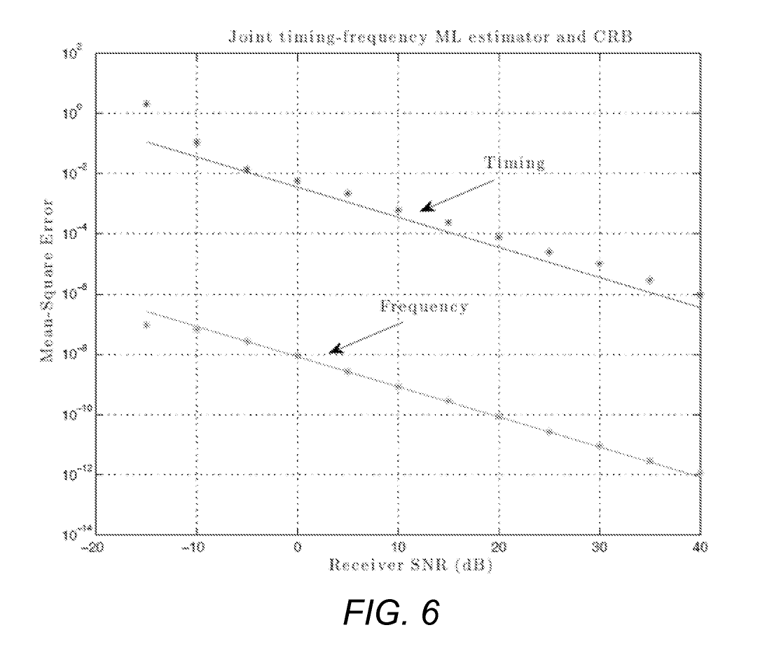

FIG. 6 illustrates an example of a CRB and simulated estimation MSE of a joint ML estimation for parameters of the example. FIG. 6 shows the CRB for δξ=0 and δμ=0, c=(1, 0.5, −0.2, 0.1, −0.05, −0.005)^{T}, with path delays (normalized with respect to Tₛ) equal to (0, 1.75, 3.56, 7.90, 10.72, 15.30), respectively, and for a pilot sequence s formed by a block of 64 pseudo-random chips with values in the QPSK constellation, repeated twice and separated by 128 chips equal to 0, for a total pilot sequence length of 256 chips, corresponding to less than 4 64-carrier OFDM symbols. (In fact, the OFDM symbols include also the cyclic prefix which here, for this time-domain pilot burst, are not necessary). The simulated estimation MSE of the joint ML estimator derived before is also shown. Extensive trial and simulation shows that pilot bursts of duration equal to 256 chips may achieve sufficiently good estimation MSE, and that in any case this may be very close to the CRB for the range of channel SNR of interest for wireless networks applications (roughly, from 0 to 40 dB).

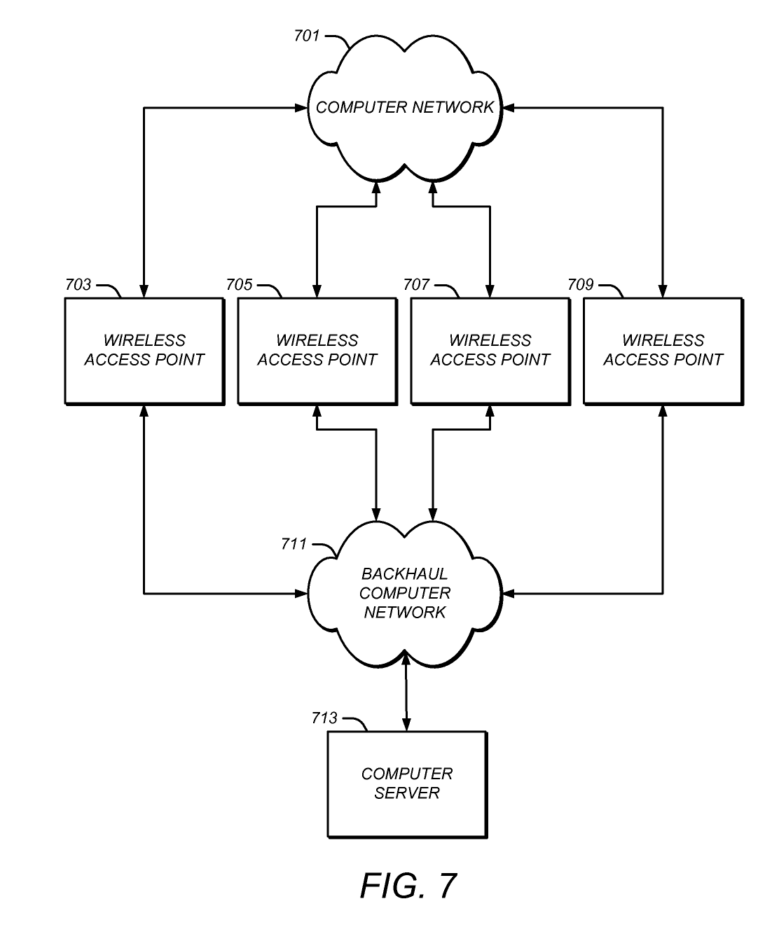

FIG. 7 illustrates an example of a computer network system having multiple wireless access points, such as wireless access points 703, 705, 707, and 709, and a computer server 713. Although only four wireless access points are illustrated in FIG. 7, the computer network system may have a different number of wireless access points, such as a smaller or much larger number.

The wireless access points may be of any type. For example, the wireless access points may be Wi-Fi wireless access points or cellular wireless access points.

The wireless access points may be configured to access to one or more computer networks, such as a computer network 701. The computer network 701 may be of any type, for example, it may consist of include the Internet, a cellular communication system, bridges, switches, and/or any combination of these. Although not shown, other computers and computer systems may be configured to communicate with the computer network 701.

The wireless access points may also be configured to communicate with the computer server 713. They may be configured to do so through a computer network system, such as through a backhaul computer network 711. The backhaul computer network 711 may be hardwired to the wireless access points or may include one or more wireless communication links. The backhaul computer network 711 may be the same as or different from the computer network 701.

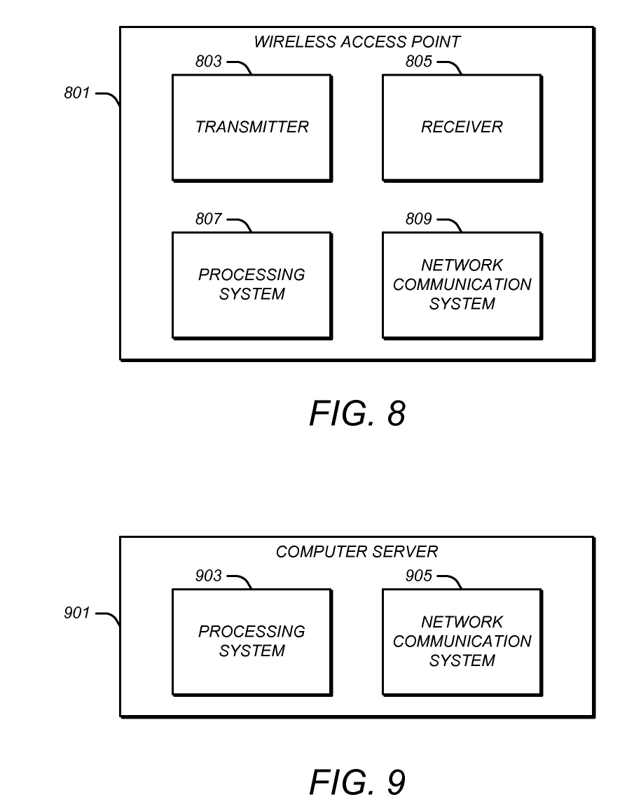

FIG. 8 is an example of a wireless access point 801. Each of the wireless access points illustrated in FIG. 7 may be the same as or different from the wireless access point 801. Similarly, the wireless access point 801 may be used in connection with network communication systems other than the one illustrated in FIG. 7.

The wireless access point 801 may include a receiver 805, a processing system 807, and a network communication system 809. The wireless access point 801 may include additional components and/or not all of these components.

The transmitter 803 may be configured to wirelessly transmit signals having a timing, carrier frequency, and/or sampling frequency, including pilot bursts, such as pilot bursts of any of the types discussed above. The transmitter 803 may have a video signal bandwidth. The transmitter 803 may be of any type, such as a Wi-Fi and/or a cellular transmitter.

The receiver 805 may be configured to wirelessly receive signals having a timing, carrier frequency, and/or sampling frequency, including pilot bursts, such as pilot bursts of any of the types discussed above. The receiver 805 may be of any type, such as a Wi-Fi and/or cellular receiver.

The network communication system 809 may be configured to communicate with a computer server, such as the computer server 713 illustrated in FIG. 7, through a computer network, such as the backhaul computer network 711. The network communication system 809 may be of any type, such as a network interface card.

The processing system 807 may have a configuration that causes various things to happen, such as the things now described. To facilitate this, the processing system 807 may include one or more computer processors, associated support devices, and one or more memories containing computer instructions and/or data.

The processing system 807 may be configured to cause the transmitter 803 to transmit pilot bursts; to determine the timing, carrier frequency, and/or sampling frequency of each pilot burst that is received by the receivers 805; to determine a timing offset between the timing of each received pilot burst and the timing of the transmitted signals; to determine a carrier frequency offset between the carrier frequency of each received pilot burst and the carrier frequency of the transmitted signals; and/or to determine a sampling frequency offset between the sampling frequency of each received pilot burst and the sampling frequency of the transmitted signals.

The configuration of the processing system 807 may be such as to determine a timing offset as small as ten, five, two, or even less nanoseconds, and/or a timing offset as small as ten, five, two, or even less times the inverse of the radio signal bandwidth of the transmitter 803.

The processing system 807 may be configured to compute the timing, carrier frequency, and/or sampling frequency offsets using a joint maximum likelihood timing estimator.

The processing system 807 may be configured to cause the network communication system 809 to deliver the determined timing, carrier frequency, and/or sampling frequency offsets to the computer server through the computer network, such as to the computer server 713 through the backhaul computer network 711.

The processing system 807 may be configured to cause the timing of the transmitter 803 to be adjusted in accordance with a timing correction factor received from the computer server over the computer network.

FIG. 9 illustrates an example of a computer server 901. The computer server 713 illustrated in FIG. 7 may be the same as or different from the computer server 901. Similarly, the computer server 901 may be used in a network communication system different from the one illustrated in FIG. 7.

The computer server 901 may include a processing system 903 and a network communication system 905. The computer server 901 may have additional components and/or not all of these components.

The processing system 903 may have a configuration that causes various things to happen, such as the things now described. To facilitate this, the processing system 903 may include one or more computer processors, associated support devices, and one or more memories containing computer instructions and/or data.

The network communication system 905 may be configured to communicate with each of the wireless access points, such as the wireless access points 703, 705, 707, and 709, through a computer network, such as the backhaul computer network 711. The network communication system 905 may be of any type, such as a network interface card.

The processing system 903 may be configured to receive a timing offset, a carrier frequency offset, and/or a sampling frequency offset from each of the wireless access points through the network communication system 905, such as from the wireless access points 703, 705, 707, and 709 communicating through a computer network with the computer server 901, such as the backhaul computer network 711. In lieu of receiving sampling frequency offsets, the processing system 903 may be configured to compute the sampling frequency offsets based on the timing offsets in and carrier frequency offsets that are received from the access points.

The processing system 903 may be configured to compute timing, carrier frequency, and/or sampling frequency correction factors for each wireless access point based on the timing, carrier frequency, and sampling frequency offsets in all of the wireless access points. The processing system 903 may be configured to do so using a least-squares algorithm and/or a smoothing filter algorithm that smoothens the correction factors in time across successive synchronization protocol slots.

The processing system 903 may be configured to cause the computed timing, carrier frequency, and/or sampling frequency offsets for each of the wireless access points to be delivered to the wireless access point through the network communication system 905 and the computer network.

The processing system 807 may be configured to cause the carrier frequency of the transmitter 803 to be adjusted in accordance with the carrier frequency correction factor received from the computer server 901 over the computer network. The processing system 807 may be configured to cause the carrier frequency of the transmitted signals to be adjusted by phase rotating transmit symbols in a baseband in accordance with the carrier frequency correction factor.

The processing system 807 may be configured to cause the sampling frequency of the transmitter 803 to be adjusted in accordance with a sampling frequency correction factor received from the computer server 901 over the computer network. The processing system 807 may be configured to cause the sampling frequency of the transmitted signals to be adjusted by a combination of phase rotation in a baseband a sample skipping scheme that repeats samples or delete samples to adjust timing alignment of transmissions.

The processing system 903 may be configured to compute the timing, carrier frequency, and/or sampling frequency correction factors in amounts that cause each of the wireless access points, following receipt of their respective correction factors, to synchronize with one of the wireless access points which is the same for all of the wireless access points.

The computer server that has been discussed includes one or more processors, tangible memories (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens).

The compute server may include one or more computers at the same or different locations. When at different locations, the computers may be configured to communicate with one another through a wired and/or wireless network communication system.

The computer server may include software (e.g., one or more operating systems, device drivers, application programs, and/or communication programs). When software is included, the software includes programming instructions and may include associated data and libraries. When included, the programming instructions are configured to implement one or more algorithms that implement one or more of the functions of the computer server, as recited herein. The description of each function that is performed by the computer server also constitutes a description of the algorithm(s) that performs that function.

The software may be stored on or in one or more non-transitory, tangible storage devices, such as one or more hard disk drives, CDs, DVDs, and/or flash memories. The software may be in source code and/or object code format. Associated data may be stored in any type of volatile and/or non-volatile memory. The software may be loaded into a non-transitory memory and executed by one or more processors.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and advantages. These also include embodiments in which the components and/or steps are arranged and/or ordered differently.

For example, the scheme at hand can incorporate any suitable timing and frequency offset estimators, not only the joint ML scheme explained above, such that the timing difference and the frequency difference between any two nodes in the network can be measured, with the aid of pilot signals or in any other suitable manner. In addition, successive measurements in time can be input to a smoothing filter (e.g., a Kalman filter) in order to improve the noise margin and the accuracy of the scheme. The timing and frequency corrections can be produced by suitably designed hardware making use of VCOs (Voltage Controlled Oscillators) instead of digitally rotating the baseband symbols as explained above. Hence, baseband digital phase rotation or frequency correction in the analog domain via a VCO may be two alternative and conceptually equivalent ways to correct timing and frequency. Both may be compatible with the correction that each node must implement in the proposed scheme.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. A wireless access point for a computer network system having multiple wireless access points comprising:
a transmitter having a configuration that wirelessly transmits signals having a timing and carrier frequency, including pilot bursts;
a receiver having a configuration that wirelessly receives signals having a timing and carrier frequency, including pilot bursts; and
a processing system having a configuration that:
causes the transmitter to transmit pilot bursts;
determines the timing and carrier frequency of each received pilot burst;
determines a timing offset between the timing of each received pilot burst and the timing of the transmitted signals; and
determines a carrier frequency offset between the frequency of each received pilot burst and the carrier frequency of the transmitted signals.

2. The wireless access point of claim 1 wherein the processing system has a configuration that can determine a timing offset as small as ten nanoseconds.

3. The wireless access point of claim 1 wherein:
the transmitter has a radio signal bandwidth; and
the processing system has a configuration that can determine a timing offset as small as ten times the inverse of the radio signal bandwidth.

4. The wireless access point of claim 3 wherein the processing system has a configuration that can determine a timing offset as small as two times the inverse of the radio signal bandwidth.

5. The wireless access point of claim 1:
further comprising a network communication system having a configuration that communicates with a computer server through a computer network; and
wherein the processing system has a configuration that causes the network communication system to deliver the determined timing and carrier frequency offsets to the computer server.

6. The wireless access point of claim 5 wherein the processing system has a configuration that causes:
the timing of the transmitted signals to be adjusted in accordance with a timing correction factor received from the computer server; and
the carrier frequency of the transmitted signals to be adjusted in accordance with a carrier frequency correction factor received from the computer server.

7. The wireless access point of claim 6 wherein the processing system has a configuration that causes the carrier frequency of the transmitted signals to be adjusted by phase rotating transmit symbols in a baseband in accordance with the carrier frequency correction factor.

8. The wireless access point of claim 6 wherein:
the signals transmitted by the transmitter have a sampling frequency; and
the processing system has a configuration that causes the sampling frequency of the transmitted signals to be adjusted in accordance with a sampling frequency correction factor received from the computer server.

9. The wireless access point of claim 8 wherein the processing system has a configuration that causes the sampling frequency of the transmitted signals to be adjusted by a combination of phase rotation in a baseband and a sample skipping scheme that repeats samples or deletes samples to adjust timing alignment of transmissions.

10. The wireless access point of claim 1 wherein the processing system has a configuration that computes the timing and carrier frequency offsets using a joint maximum likelihood timing estimator.

11. A computer server for a computer network that includes wireless access points comprising:
a network communication system having a configuration that communicates with the wireless access points through the computer network; and
a processing system having a configuration that:
receives a timing offset and a carrier frequency offset from each of the wireless access points that is representative of a timing offset and a carrier frequency offset between the wireless access point and another of the wireless access points; and
for each wireless access point:
computes a timing correction factor and a carrier frequency correction factor based on the timing and carrier frequency offsets received from the wireless access points; and
causes the timing and carrier frequency correction factors for the wireless access point to be delivered to the wireless access point through the computer network system.

12. The computer server of claim 11 wherein the computer network is a backhaul computer network.

13. The computer server of claim 11 wherein the processing system has a configuration that:
receives a sampling frequency offset from each of the wireless access points that is representative of a sampling frequency offset between the wireless access point and another of the wireless access points;
computes a sampling frequency correction factor for each wireless access point based on the sampling frequency offsets received from the wireless access points; and
causes the sampling frequency correction factor for each wireless access point to be delivered to the wireless access point through the computer network system.

14. The computer server of claim 11 wherein the processing system has a configuration that:
computes a sampling frequency offset between each wireless access point and another of the wireless access points based on the timing offset and the carrier frequency offset received from the access point;
computes a sampling frequency correction factor for each wireless access point based on the sampling frequency offsets computed for the wireless access points; and
causes the sampling frequency correction factor for each wireless access point to be delivered to the wireless access point through the computer network system.

15. The computer server of claim 11 wherein the processing system has a configuration that computes the timing, carrier frequency, and sampling frequency correction factors using a least-squares algorithm.

16. The computer server of claim 11 wherein the processing system has a configuration that computes the timing, carrier frequency, and sampling frequency correction factors in amounts that cause each of the wireless access points upon receipt of their respective correction factors to synchronize with one of the wireless access points which is the same for all of the wireless access points.

17. The computer server of claim 11 wherein the processing system has a configuration that computes the timing, carrier frequency, and sampling frequency correction factors using a smoothing filter algorithm that smoothens the correction factors in time across successive synchronization protocol slots.

18. A computer network system comprising:
multiple wireless access points, each of the type recited in claim 1; and
a computer server of the type recited in claim 11,
wherein:
each wireless access point further comprises a network communication system having a configuration that communicates with the computer server through the computer network; and
the processing system in each wireless access point has a configuration that causes:
the network communication system in that wireless access point to deliver the timing and carrier frequency offsets determined by that wireless access point to the computer server; and
the timing of the signals transmitted by that wireless access point to be adjusted based on the timing correction factor received by that wireless access point from the computer server; and
the carrier frequency of the signals transmitted by that wireless access point to be adjusted based on the carrier frequency correction factor received by that wireless access point from the computer server.

19. The computer network system of claim 18 wherein:
the signals transmitted by the transmitter in each wireless access point have a sampling frequency;
the processing system in the computer server:
computes a sampling frequency correction factor for each wireless access point based on sampling frequency offsets between the sampling frequency of each wireless access point and the sampling frequency of another wireless access point; and
causes the sampling frequency correction factor for each wireless access point to be delivered to the wireless access point through the computer network system; and
the processing system in each wireless access point has a configuration that causes the sampling frequency of its transmitted signals to be adjusted in accordance with the sampling frequency correction factor received from the computer server.

20. The computer network system of claim 18 wherein the computer network is a backhaul computer network.
